(19) United States
(12) Patent Application Publication
(10) Pub. No.: US 2018/0374147 A1
(43) Pub. Date: Dec. 27, 2018

(54) Bid Generator

(71) Applicant: MediaGamma Ltd, London (GB)

(72) Inventors: Jun Wang, London (GB); Weinan Zhang, London (GB)

(21) Appl. No.: 15/631,715

(22) Filed: Jun. 23, 2017

(51) Int. Cl. G06Q 30/08

(52) U.S. Cl. CPC G06Q 30/08; G06Q 30/06

(57) ABSTRACT

A method of generating a bid in an auction for a space to serve web content is provided. The method comprises providing (S102) a training data set of historic auctions, including a first category of data items regarding successful bids and a second category of data items regarding unsuccessful bids, wherein both categories include the bid prices for the historic auctions and the first category includes a market price for the historic auctions; determining (S104) a prior probability of success for each item in the first category based on the market price and the knowledge that for items in the second category the market price was higher than the bid price; determining (S106) a weighting for each item in the first category based on the prior probability; estimating (S108) a parameter based on the training data set and the weighting for items in the first category; receiving data about the space to serve web content; using (S114) the estimated parameter and the data about the space to serve web content in the generation of a bid; and sending (S116) the generated bid to an auction host.

### BACKGROUND

In real-time display advertising, advertisements are sold per impression via an auction mechanism. For an advertiser, the campaign information is incomplete as the user responses (for example, clicks or conversions) and the market price of each ad impression are observed only if the advertiser's bid wins the corresponding ad auction. The predictions, such as bid landscape forecasting, click-through rate (CTR) estimation, and bid optimisation, are all operated in the pre-bid stage with full-volume bid request data. However, the training data is gathered in the post-bid stage with a strong bias towards the winning impressions as only statistics about winning impressions are observed. This bias reduces the accuracy of any predictions (such as optimal bids, click-through rate, and conversion rate) made, and there has been no satisfactory way to deal with this bias. An object of the invention is to improve predictions by reducing bias in the training data and thereby improve generated bids.

### SUMMARY OF INVENTION

In a first aspect of the invention a method is provided for generating a bid in an auction for a space to serve web content. In the first step of the method a training data set of historic auctions is provided, which includes a first category of data items regarding successful bids and a second category of data items regarding unsuccessful bids, wherein both categories include the bid prices for the historic auctions and the first category includes a market price for the historic auctions. A prior probability of success is then determined for each item in the first category based on the market price and the knowledge that for items in the second category the market price was higher than the bid price, and this is then used to determine a weighting for each item in the first category. A parameter is estimated based on the training data set and the weighting for items in the first category and this parameter is used in the generation of a bid in a current auction.

The training data set in an auction environment is typically incomplete as only successful bids are provided with additional information regarding the market price of the space to serve web content, and data is therefore biased towards winning bids. It follows that the data set is biased towards historic bids in which the bid price was high. This leads to inaccuracy in the estimation of parameters relating to the space to serve web content as the user interaction with a high value space will be different from the user interaction with a low value space, and as such these parameters are less useful in the generation of bids. It is therefore necessary to remove the bias from the data set. Previous approaches have made assumptions about the missing data in order to reweight the data collected and thereby remove the bias, whereas the present method incorporates the second category of data items into a determination of the prior probability of success of items in the first category, and this prior probability of success is used to reweight the data items. By incorporating the second category of data items the reweighting of the data items is more accurate, and there is a corresponding increase in the reliability of the parameters estimated by the method.

As noted above, the bias in the training data means that there is limited information about bids for low value spaces. This is problematic as low value spaces are often the most cost effective, making them of particular interest to advertisers. The present method is therefore particularly advantageous in that bids may accurately be generated for spaces to serve web content where the price is low.

The training data set will typically be collected during real-time auctions for spaces to serve web content. Each bid sent to an auction host is recorded for use in a training data set, and data received from the auction host after the bid has been placed is also recorded. This includes a notification of whether the bid was won or lost and, in the case of a win, the market price of the space to serve web content. The data received after the bid has been placed will also typically include impressions and tracked user behaviour, such as clicks and conversions. The data items are then categorised into the first or second category.

Bids generated by the method may also be incorporated into the training data set, which provides a synergistic benefit in combination with the method's improved accuracy when generating bids for spaces to serve web content where the price is low. By using this method, more bids will be won for spaces to serve web content where the price is low, and this leads to more data items in the first category of data items for which the price is low. As the method is directed towards removing this exact type of bias in a training data set, this is especially beneficial. These bids are incorporated into the training data set in the same way as bids not generated using the method.

The method is also advantageous in that the training step of the method may be performed offline. Previous methods have focussed on optimizing a bidding strategy online, which is to say that the model is updated in real time as new data becomes available. However, learning a model online is expensive and time consuming. In contrast, offline learning trains a model using a historic data set. However, the historic data collected is quite often incomplete and biased. As such, it does not reflect the properties and characteristics of the online data when the algorithms operate online. Existing solutions that ignore the bias would fail. The present method efficiently and automatically corrects the bias from the offline historic data and as such is able to train the model offline while remaining relevant to online cases. Nevertheless, this does not exclude the incorporation of bids generated by the present method into the training data set.

The space to serve web content could be a space on a web page, or it could also be a space in a mobile application, although the present invention is not limited to these two examples.

The web content may be an advertisement, for which the present method is especially advantageous. Bidding for spaces to serve advertisements on a web page occurs automatically when a user visits said web page, and there is therefore a need for an automated method of generating bids. The above method is advantageous in that it allows parameters relevant to a bid for the space to be estimated, and this enables automatic generation of a bid for the space to serve an advertisement. Similar bidding processes occur for spaces to serve advertisements in a mobile application.

The prior probability of success is preferably determined through the use of a survival model. The survival model treats the market price of a bid as analogous to the “lifetime” of that bid, and the bid price as analogous to the day of the observation. The model then determines the probability that a bid will not “survive” to day b (where b is the bid price) based partly on how many bids have a lifetime z>b (where z is the market price) and on how many bids were lost with a higher bidding price. Survival models have been well studied in the field of mathematics, but they have never been applied to an auction environment. The present method therefore has significant advantages over the prior art.

The weighting for each data item in the first category may be the inverse of the prior probability of success for that item. This reflects that for data items in the first category with a low prior probability of success, there are likely to be a high number of similar data items in the second category for which there is missing data. In contrast, data items in the first category for which the bid price is high will have a high prior probability of success and will therefore be highly representative of the true data distribution.

The step of estimating a parameter preferentially involves determining a measure of the deviation of an initial estimate of the parameter from the historic data instances in the first category of data items, and iteratively adjusting the parameter until this deviation is minimized.

Several parameters can be estimated, including parameters related to a click-through rate (CTR) or a conversion rate (CVR). In these specific instances the first category of data items will also respectively include a click-through rate or a conversion rate of the historic data instances. The method is especially suited to generating a bid based on CTR or CVR as these are instances where the bias in the training data set is especially problematic. The value of a space to serve web content is based partly on the likelihood that a user will interact with it, and as such a high value space is likely to have a high click-through and conversion rates. If a parameter for estimating CTR or CVR is trained on data biased towards high value spaces, then the parameter is likely to overestimate the click-through or conversion rates, respectively, of low value spaces. The present method overcomes this problem.

The data about the space to serve web content is typically received from the auction host and includes multiple fields of data, such as: the current time; user location (for example city, region, and/or country); the user device (including the type of device and the device brand, as these both have implications for the value of the space to serve web content); software used by the user (including operating system, browser, and APP); information about the publisher (including URL, domain, and category); and information about the space itself, which in embodiments where the web content is an advertisement includes information about the ad exchange, ad creative ID, ad size, campaign ID, and campaign category. The information about the user can also include the user's IP address along with their demographic data, interest tags, and details of their historic browsing.

The training data set typically also includes data received from an auction host during historic auctions. As such, the values that may be taken by the fields of data are fixed once the training data has been collected, and if a new value for a field is observed during a real-time auction then that value is given a predetermined value, for example “OTHER”. As a specific example, the training data set may include “New York”, “London”, and “Paris” as locations. If the user information in a real-time auction indicates that a user is in Berlin, then their location value would be given as “OTHER”, rather than as “Berlin”.

The data about the space to serve web content preferably converted into a feature vector by the method of one-hot encoding. One-hot encoding is a method of converting features into numerical values that may be used when each feature may take only predetermined non-numerical values. When there are n possible non-numerical values a feature can take, the feature i is assigned a numerical value of

$$\begin{matrix}non \text{-} numerical value & 1 & … & i & … & n \\ numerical value & 0 & … & 1 & … & 0\end{matrix} .$$

As the features now have numerical values, they are suitable of use in machine learning.

In the above specific example, the locations “New York”, “London”, and “Paris” could be given the respective values of 1, 2 and 3. However, this would imply that “New York”<“London”, which does not make sense in view of the type of data. One-hot encoding overcomes this issue by assigning the locations values as

$$\begin{matrix}New York & London & Paris & OTHER \\ 1000 & 0100 & 0010 & 0001\end{matrix} .$$

In a second aspect of the invention a computer-readable memory is provided which stores instructions for the generation of a bid in an auction for a space to serve web content. When carried out by a processor, those instructions cause the processor to perform several steps, starting with providing a training data set of historic auctions, including a first category of data items regarding successful bids and a second category of data items regarding unsuccessful bids, wherein both categories include the bid prices for the historic auctions and the first category includes a market price for the historic auctions. The processor then performs the step of determining a prior probability of success for each item in the first category based on the market price and the knowledge that for items in the second category the market price was higher than the bid price, followed by determining a weighting for each item in the first category based on the prior probability. A parameter is then estimated based on the training data set and the weighting for items in the first category, data about the space to serve web content is received, and both the estimated parameter and the data about the space to serve web content are used in the generation of a bid. The generated bid is then sent to the auction.

In a third aspect of the invention a system is provided for generating a bid in an auction for a space to serve web content. The system comprises an auction host, a data collection unit, a parameter training unit, and a bidding unit. The data collection unit is configured to store a training data set of historic auctions, the training data set including a first category of data items regarding successful bids and a second category of data items regarding unsuccessful bids, wherein both categories include the bid prices for the historic auctions and the first category includes a market price for the historic auction. The parameter training unit is configured to receive the training data set from the data collection unit and to: determine a prior probability of success for each item in the first category based on the market price and the knowledge that for items in the second category the market price was higher than the bid price; determine a weighting for each item in the first category based on the prior probability; and estimate a parameter based on the training data set and the weighting for items in the first category. The bidding unit is configured to: receive the estimated parameter from the parameter training unit; receive data about the space to serve web content from the auction host; use the estimated parameter and the data about the space to serve web content in the generation of a bid; and send the generated bid to the auction host.

### BRIEF DESCRIPTION OF THE FIGURES

Embodiments of the invention are now described, by way of example, with reference to the drawings, in which:

FIG. 1 is a schematic view of a system for generating a bid in an auction for space to serve web content;

FIG. 2 is a schematic view of the subsystems of the parameter training unit;

FIG. 3 is a schematic view of the steps involved in a live auction for an advertisement;

FIG. 4 is a flowchart showing the steps performed by the system for generating a bid in an auction for space to serve web content;

FIG. 5 is a schematic view of an alternative embodiment of a system for generating a bid in an auction for space to serve web content;

FIG. 6 is a schematic view of the subsystems of the parameter training unit in the alternative embodiment; and

FIG. 7 is a schematic view of the subsystems of a different embodiment of the parameter training unit in the alternative embodiment.

### DETAILED DESCRIPTION OF THE FIGURES

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

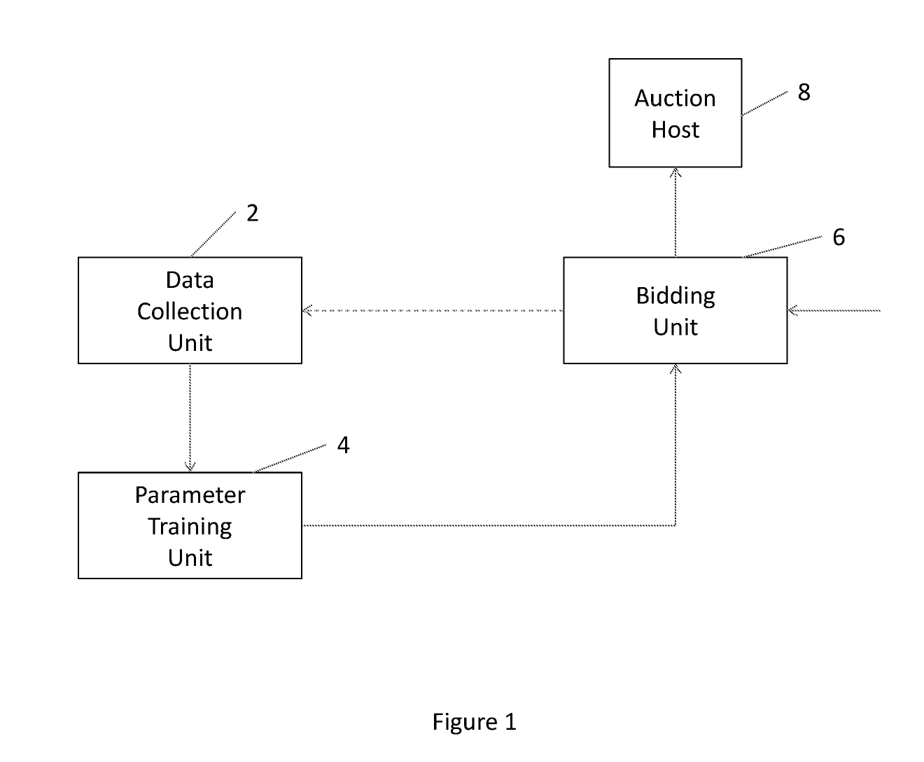

FIG. 1 is a schematic view of a system for generating a bid in an auction for space to serve web content. The system includes a data collection unit 2, a parameter training unit 4, a bidding unit 6, and an auction host 8.

The data collection unit 2 stores a training data set including data items regarding historic auctions. The data set includes a first category of data items regarding successful bids in historic auctions, and a second category of data items regarding unsuccessful bids. The bid price and the user reaction (for example, whether or not there was a click or conversion) are only observed by an advertiser if the advertiser's bid wins the auction, and as such the data items in the second category are incomplete.

The data collection unit 2 may also collect data about bids from the bidding unit 6, including a bid price and, in the case of a winning bid, data about the space to serve web content. This data is then categorised by the data collection unit 2 into the first category or the second category.

The training data set is provided to the parameter training unit 4 for estimating a parameter to be used in the generation of a bid. As the data items in the second category are incomplete, only the first category of data items is suitable for estimating the parameter. However, the data items in the first category of the data set are biased towards having a high bid price, and this bias therefore needs to be accounted for in order to train the parameter accurately. To do this, the parameter training unit 4 first determines a prior probability of success for each data item in the first category. This prior probability of success is a good measure of the degree to which respective data items are over- or underrepresented in the first category, and can therefore be used to determine a weighting for each data item in the first category. The respective weighting of each data item is then applied when estimating the parameter. The estimated parameter is then provided to the bidding unit 6.

The bidding unit 6 receives data about the space to serve web content from the auction host, and this data may be used in conjunction with the estimated parameter to generate a bid for the space to serve web content. The generated bid is then sent to the auction host 8, which responds with a notification of success or failure.

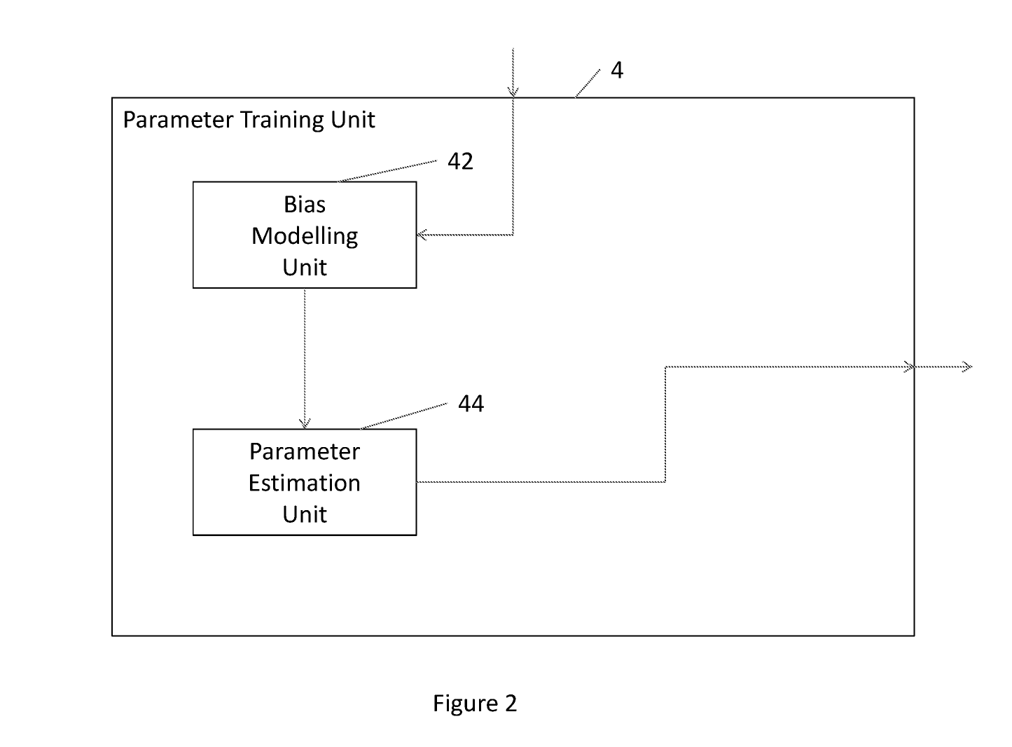

The subsystems of the parameter training unit 4 are shown in more detail in FIG. 2. These include a bias modelling unit 42 and a parameter estimation unit 44.

The bias modelling unit 42 receives the training data set provided by the data collection unit 2. In order to model the bias in the training data, the bias modelling unit 42 first determines the prior probability of success for each item in the first category of data items. This is a useful approach as data items with a low prior probability of success are likely to be under represented, while items with a high prior probability of success are correspondingly likely to be over represented. These prior probabilities may then serve as to indicate the degree to which individual data items need to be reweighted when making predictions.

In order to determine the prior probability of success for the data items in the first category, the bias modelling unit 42 implements a survival model incorporating all the data items from both categories. This is beneficial as, although the market price of data items in the second category is unknown, by using a survival model the prior probability of success is based partly on the knowledge that for a given data item in the second category the market price is higher than the bid price. This increases the accuracy of the prior probability of success.

The function of the survival model can be seen by considering how the winning probability might be estimated in the absence of a bias in the data. In this case the probability wₒ(bₓ) that an auction will win with a bid of bₓ is given by

$${w}_{o} ( {b}_{x} ) = \frac{number of bids with market price < {b}_{x}}{total number of bids} .$$

Introducing a data bias is then equivalent to undercounting the denominator, which results in a winning probability which is too high. We can correct this by including items in the second category in the count for the total number of bids, but this is problematic as the market price for items in the second category is unknown, and as such a method for including these items in the numerator is needed. This is where the survival model is useful.

The survival model is implemented by analogising price values as days in a study. In this analogised study it is desired to find the lifetime of an item. However, items may leave the study early and their lifetime will be unknown, and a survival model is used to estimate the lifetimes of these items. By analogising the bid price and market price of data items as the day of observation of a bid and a “lifetime” of that bid, respectively, we may estimate the market price of items in the second category of data items. The probability that a given a bid bᵢ will lose is then equivalent to the probability l(b₁) that a given bid will not “survive” to day i. This may then be used to determine the prior probability of success w(bᵢ)=1−l(bᵢ), which is equivalent to the probability that a given bid will survive to day i.

The weighting for a given data item may then be determined using the prior probability of success determined by the survival model. Typically the weighting is the inverse of the prior probability of success, although other methods of weighting the data items may be used.

A survival model is an especially beneficial method of determining the prior probability of success as the expression for the prior probability of success has O(N) complexity, making the survival model as highly computationally efficient method of determining the prior probability of success.

The data items in the first category of the training data set and their respective weights are then received by the parameter estimation unit 44. The parameter estimation unit 44 first determines a measure of the deviation of the parameter from the historic data instances in the first category. A fully optimized parameter would have no deviation from the historic data instances, and would therefore give the most accurate predictions, and the parameter estimation unit attempts to achieve this by iteratively varying an initial estimate of the parameter.

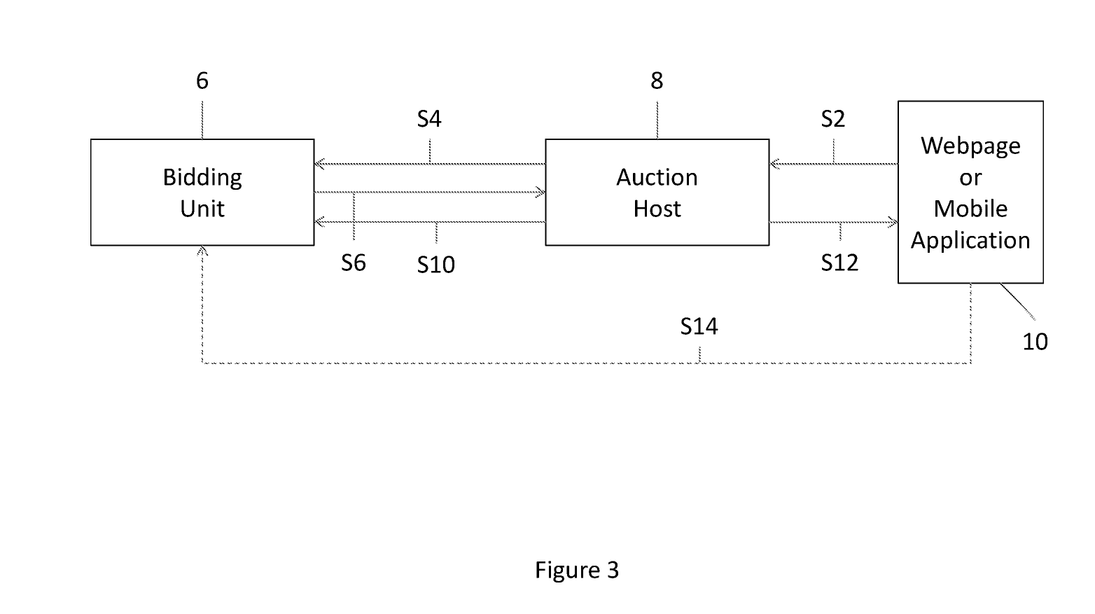

FIG. 3 shows the various stages involved in a real-time auction for a space to serve web content. When a user visits a webpage 10 a request S2 is sent to an auction host 8, which then sends a bid request S4 to a bidding unit 6. The bidding unit 6 then sends a bid response S6 to the auction host which includes a bid price for the space to serve web content. Following a real-time auction the bidding unit 6 is then notified in step S10 whether or not the bid was successful. In the event that the bid was successful then the web content is provided in step S12 to the webpage 10 including tracking, and the web content is then displayed on the webpage. This tracking then sends the bidding unit data including the user response (for example clicks and conversions). In the case of a win, the auction host 8 will also send the bidding unit 6 the market price for the space to serve web content.

The process depicted in FIG. 3 is equally applicable when the web content is not to be displayed on a webpage, for example when an advertisement is to be included in a mobile application, in which case the process begins when a user opens mobile application 10.

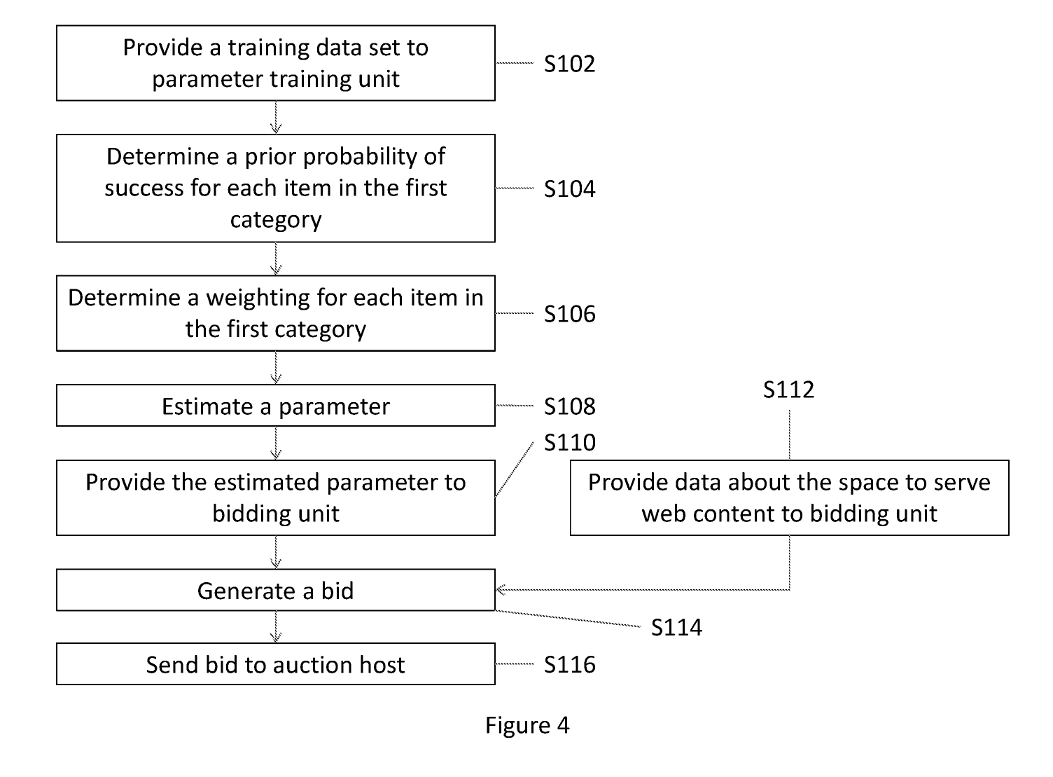

The steps carried out by the system are shown in more detail in FIG. 4.

In step S102 the data collection unit 2 provides the training data set to the parameter training unit 4. The parameter training unit 4 then determines a prior probability of success for each item in the first category in step S104, determines a weighting for each item in the first category in step S106, and estimates a parameter in step S108. This parameter is then provided in step S110 to the bidding unit 6.

The bidding unit 6 is also provided with data about the space to serve web content in step S112, and in step S114 this is used in conjunction with the estimated parameter to generate a bid, which is sent to the auction host 8 in step S116.

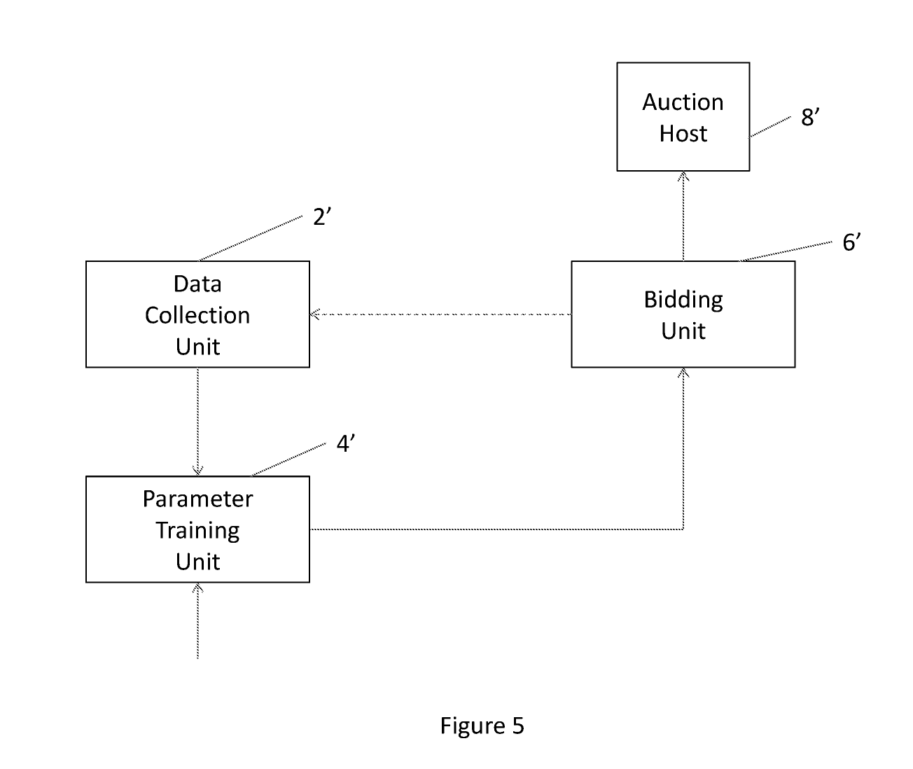

FIG. 5 shows an alternative embodiment of the system where the data about the space to serve web content is received by the parameter training unit 4′, rather than the bidding unit 6′. In this embodiment, the parameter training unit 4′ provides a valuation of the space to serve web content to the bidding unit, which then generates a bid based on this valuation.

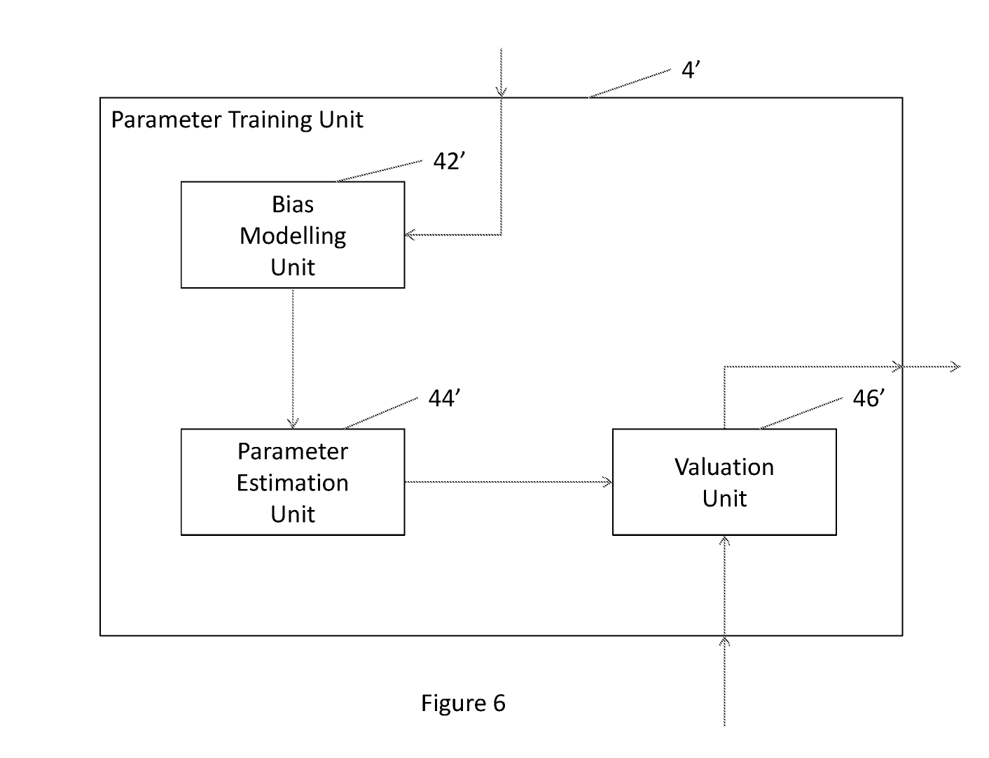

FIG. 6 shows the parameter training unit 4′ in more detail. In this embodiment, the parameter training unit comprises a valuation unit 46′ in addition to the bias modelling unit 42′ and parameter estimation unit 44′. The parameter estimation unit 44′ provides the estimated parameter to the valuation unit 46′, which also receives data about the space to serve web content.

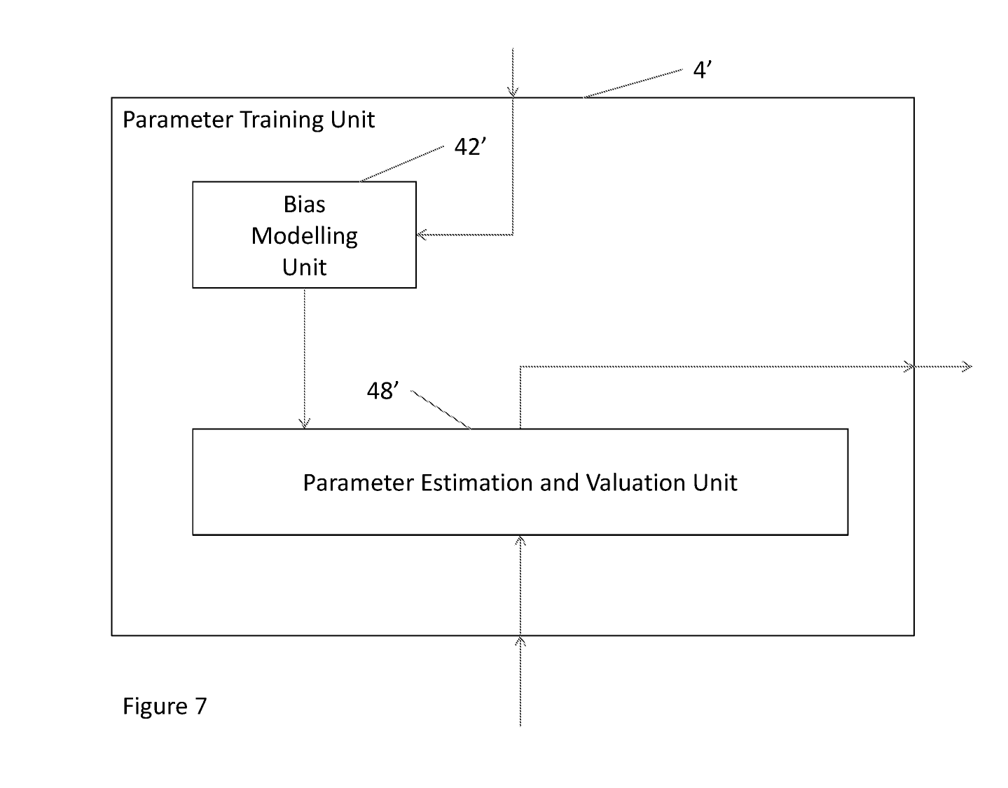

FIG. 7 shows a different embodiment of the parameter estimation unit 4′ in which the parameter estimation and valuation are performed by the same subsystem 48′.

In a preferred embodiment of the invention, the survival model is implemented as follows. The data items in the training data set are expressed as [symbol] bᵢ, wᵢ, zᵢ [symbol] _{i=1 . . . N}, where bᵢ is the bid price of the auction, wᵢ indicates whether the bid won or lost, and zᵢ is the market price (known only if the bid won). The survival model then converts these data items into the form [symbol] bⱼ, dⱼ, nⱼ [symbol] _{j=1 . . . M}, where b_{b}<bⱼ₊₁, dⱼ is the number of winning cases with the market price exactly equal to bⱼ−1 (which is equivalent to the number of bids with “lifetime” bⱼ), and nⱼ is the number of data items which cannot be won with bid price bⱼ−1. The losing probability for a bid bₓ is then:

$$l ( {b}_{x} ) = {Π}_{{b}_{j} < {b}_{x}} \frac{{n}_{j} - {d}_{j}}{{n}_{j}}$$

which gives a winning probability of:

$$w ( {b}_{x} ) = 1 - {Π}_{{b}_{j} < {b}_{x}} \frac{{n}_{j} - {d}_{j}}{{n}_{j}}$$

This calculation of the winning probability is highly computationally efficient, as it is O(N).

In a preferred embodiment of the invention optimised for CTR estimation for an advertisement, the parameter is estimated by minimising a loss function L based on a training data set D={(x,y,z)}, where x is a bid request vector, y is the user interaction with ad, and z is market price of the ad. In the historic data set the bid request vector follows a probability distribution qₓ(x)=w(bₓ)pₓ(x), where w(bₓ) is the prior probability of winning and pₓ(x) is the ground truth distribution of the data. The minimisation of the loss function is then formalised as:

$${min}_{θ} {x ∼ {p}_{x} ( x )}_{} [ ( y , {f}_{θ} ( x ) ) ] + λΦ ( θ )$$

The function ƒ_{θ}(x) in the equation gives the estimated value of the click-through rate and is equal to θ^{T}x, and the function Φ(θ) is regularisation term with weight λ.

The expectation term may be written as:

$${x ∼ {p}_{x} ( x )}_{} [ ( y , {f}_{θ} ( x ) ) ] = {\int }_{x} {p}_{x} ( x ) ( y , {f}_{θ} ( x ) ) dx = {\int }_{x} {q}_{x} ( x ) \frac{ ( y , {f}_{θ} ( x ) )}{w ( {b}_{x} )} dx = {x ∼ {q}_{x} ( x )}_{} [ \frac{ ( y , {f}_{θ} ( x ) )}{w ( {b}_{x} )} ] = \frac{1}{\vert D \vert} {\sum }_{( x , y , z ) ∈ D} \frac{ ( y , {f}_{θ} ( x ) )}{w ( {b}_{x} )} = \frac{1}{\vert D \vert} {\sum }_{( x , y , z ) ∈ D} \frac{ ( y , {f}_{θ} ( x ) )}{1 - {Π}_{{b}_{j} < {b}_{x}} \frac{{n}_{j} - {d}_{j}}{{n}_{j}}}$$

where w(bₓ) has been rewritten using a survival model.

In this embodiment, a logistic loss function is used and the user interaction is

$$y = \{ \begin{matrix}- 1 for no click \\ + 1 for a click\end{matrix} ,$$

giving the minimisation problem as:

$${min}_{θ} \frac{1}{\vert D \vert} {\sum }_{( x , y , z ) ∈ D} \frac{log ( 1 + {e}^{- y {θ}^{T} x} )}{w ( {b}_{x} )} + \frac{λ}{2} \vert \vert θ {\vert \vert}_{2}^{2}$$

where L2 regularisation has been used.

An iterative solution for the parameter θ may be found by stochastic gradient descent to give a “Bid-aware Gradient Descent”:

$$θ ← ( 1 - η \cdot λ ) θ + \frac{η \cdot y \cdot {e}^{- y {θ}^{T} x} \cdot x}{( 1 + {e}^{- y {θ}^{T} x} ) ( 1 - {Π}_{{b}_{j} < {b}_{x}} \frac{{n}_{j} - {d}_{j}}{{n}_{j}} )}$$

This allows the parameter θ to be estimated. This solution may also be applied to an estimate of the conversion rate for an advertisement by taking the user interaction as

$$y = \{ \begin{matrix}- 1 for no conversion \\ + 1 for a conversion\end{matrix} .$$

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of generating a bid in an auction for a space to serve web content, comprising the steps of:
providing a training data set of historic auctions, including a first category of data items regarding successful bids and a second category of data items regarding unsuccessful bids, wherein both categories include the bid prices for the historic auctions and the first category includes a market price for the historic auctions;
determining a prior probability of success for each item in the first category based on the market price and the knowledge that for items in the second category the market price was higher than the bid price;
determining a weighting for each item in the first category based on the prior probability;
estimating a parameter based on the training data set and the weighting for items in the first category;
receiving data about the space to serve web content;
using the estimated parameter and the data about the space to serve web content in the generation of a bid; and
sending the generated bid to an auction host.

2. The method of claim 1, wherein the web content is an advertisement.

3. The method of claim 1, wherein the training data set is collected during historic real-time auctions.

4. The method of claim 1, wherein determining the prior probability of success for a data item in the first category includes:
determining the bid price of the data item;
determining how many data items in the first category have a market price less than the bid price of the data item;
estimating how many data items in the second category have a market price less than the bid price of the data item; and
estimating the prior probability of success of a bid with the bid price of the data item.

5. The method of claim 1, wherein the weighting for each item in the first category is proportional to the inverse of the prior probability of success for that item.

6. The method of claim 1, wherein the step of estimating the parameter includes determining a measure of the deviation of an initial estimate of the parameter from the historic data instances in the first category of data items, and iteratively adjusting the parameter to reduce this deviation.

7. The method of claim 1, wherein the parameter allows a click-through rate to be estimated.

8. The method of claim 1, wherein the parameter allows a conversion rate to be estimated.

9. The method of claim 1, wherein the first category also includes information about the user response to the web content.

10. The method of claim 1, wherein the data about the space to serve web content includes information about a user to whom the space is presented.

11. The method of claim 10, wherein the non-numerical data about the space to serve web content is converted into numerical values.

12. The method of claim 1, wherein the generation of a bid includes using the estimated parameter and the data about the space to serve web content to estimate a value of the space to serve web content.

13. The method of claim 1, further including the step of updating the training data set to include the generated bid.

14. A computer-readable memory storing instructions for the generation of a bid in an auction for a space to serve web content which, when carried out by a processor, cause the processor to perform the steps of:
providing a training data set of historic auctions, including a first category of data items regarding successful bids and a second category of data items regarding unsuccessful bids, wherein both categories include the bid prices for the historic auctions and the first category includes a market price for the historic auctions;
determining a prior probability of success for each item in the first category based on the market price and the knowledge that for items in the second category the market price was higher than the bid price;
determining a weighting for each item in the first category based on the prior probability;
estimating a parameter based on the training data set and the weighting for items in the first category;
receiving data about the space to serve web content;
using the estimated parameter and the data about the space to serve web content in the generation of a bid; and
sending the generated bid to an auction host.

15. A system for generating a bid in an auction for a space to serve web content, the system comprising:
an auction host;
a data collection unit configured to store a training data set of historic auctions, including a first category of data items regarding successful bids and a second category of data items regarding unsuccessful bids, wherein both categories include the bid prices for the historic auctions and the first category includes a market price for the historic auctions;
a parameter training unit configured to receive the training data set from the data collection unit and to:
determine a prior probability of success for each item in the first category based on the market price and the knowledge that for items in the second category the market price was higher than the bid price;
determine a weighting for each item in the first category based on the prior probability; and
estimate a parameter based on the training data set and the weighting for items in the first category; and
a bidding unit configured to:
receive the estimated parameter from the parameter training unit;
receive data about the space to serve web content from the auction host;
use the estimated parameter and the data about the space to serve web content in the generation of a bid; and
send the generated bid to the auction host.
